(19) United States
(12) Patent Application Publication
(10) Pub. No.: US 2009/0089984 A1
(43) Pub. Date: Apr. 9, 2009

(54) Eyeglasses Clip Kit and Method of Attaching

(76) Inventors: Richard Paul Warren, San Luis Obispo, CA (US); David Neal Sinclair, Jamestown, CA (US)

Correspondence Address: Richard P. Warren;David N. Sinclair, 6767 O'Byrnes Ferry Road, Jamestown, CA, 95327, US

(21) Appl. No.: 12/235,523

(22) Filed: Sep. 22, 2008

Related U.S. Application Data
(60) Provisional application No. 60/974,753, filed on Sep. 24, 2007.

(51) Int. Cl. G02C 11/00

(52) U.S. Cl. 24/457

(57) ABSTRACT

The present invention is a pocket clip kit for eyeglasses. One embodiment includes a one-piece pinch pocket clip made from a single piece of resilient spring material and including a pinch feature that allows conventional eyeglasses to be easily clipped onto a pocket. The invention also includes a method of attachment of a suitable spring clip to the eyeglasses using heat shrink tubing. The pinch or spring feature allows the user to open the clip while inserting the eyeglasses into a pocket. When the pinch tab is released, the clip securely grips the pocket fabric against the heat shrink tubing. The objective is to provide a device which easily attaches to a pair of eyeglasses allowing the eyeglasses to clip onto a pocket, and thus preventing the eyeglasses from inadvertently falling out of the pocket and being damaged.

### CROSS-REFERENCE TO RELATED APPLICATIONS

This application claims the benefit of earlier priority based upon the filing of a provisional application, U.S. Ser. No. 60/974,753 Titled “Add-On Pocket Clip for Eyeglasses” which was filed on Sep. 24, 2007.

### BACKGROUND OF THE INVENTION

1. Field of the Invention

This invention relates generally to an eyeglasses clip kit and method of attaching the clip to an element of an eyeglass frame. More specifically, the invention relates to the association of a unitary bent wire clip to a temporal/earpiece element of an eyeglass frame using surrounding heat shrinkable tubing.

2. Background

There are a number of individuals who wear eyeglasses for a particular purpose and do not need to wear them constantly. For example, many individuals will need to wear eyeglasses for reading, but can see fine without eyeglasses when they are not reading. Similarly, individuals who are outside on sunny days will frequently wear sun glasses, but will remove the sun glasses when they come inside or it gets cloudy or dark outside. Many people who are wearing eyeglasses and then find it necessary or desirable to remove the eyeglasses will then put the eyeglasses in a pocket, for example a shirt or jacket pocket. While such a pocket can be a convenient place to keep eyeglasses that are not in use, it can also be a hazardous place to keep them as well. It is not at all uncommon for individuals to forget that they have placed eyeglasses in a pocket, which can become particularly problematic if and when the individual bends over, for example. In such a situation the eyeglasses can and do frequently fall out of the pocket and onto the ground. This can sometimes result in the breaking of the eyeglasses, but more frequently it will result in the scratching of the surface of the lenses.

Currently there are a number of solutions for securing eyeglasses inside a pocket, but all of the known solutions suffer from one or more drawbacks. Some of these solutions attempt to secure eyeglasses inside a pocket using a plastic or metal alligator clip and attaching it to the temple piece of a pair of eyeglasses using plastic cement glue. This invention is functional but glue is prone to failure, and may damage the eyeglasses. Other solutions attempt to provide a pocket clip for eyeglasses by utilizing o-rings to secure a spring clip to the eyeglasses. Still other solutions seek to provide a pocket clip for eyeglasses utilizing bendable attachment teeth to hold itself to the eyeglasses side piece along with the application of epoxy or resin to bond the teeth to the side piece. These methods also are functional but these solutions can be damaging to the eyeglasses. These solutions are also difficult to execute without expertise and special tools. Further, these methods do not provide for a one-piece clip with a pinch tab for ease of insertion and removal into a shirt pocket.

Therefore, it would be desirable to have a device capable of easily being attached to a pair of eyeglasses or other device commonly held in a pocket, such as but not limited to: a thermometer, pencil, pen or any other item with an appropriate cross section that would benefit from being held in a shirt pocket.

### SUMMARY OF THE INVENTION

The present invention advantageously fills the aforementioned deficiencies by providing a clip for a pair of eyeglasses or other similar item that can be easily attached utilizing heat shrink tubing and a match, cigarette lighter or heat gun. In fact, the present invention can be packaged as a kit with all of the components necessary to attach a clip to a pair of eyeglasses according to a method associated with this invention.

The present invention is a kit that may be sold commercially and which contains all the pieces necessary to attach a clip, such as a pinch clip, to a pair of eyeglasses utilizing heat shrink tubing as the preferred method of attachment. The actual shape of the preferred pinch clip allows the clip to be manufactured from a single piece of resilient spring material, utilizing precisely located bends, preferably 5 bends, which make it possible to have the off-set pinch feature for ease of securing eyeglasses to a shirt pocket. Any suitable spring clip (i.e, 2-piece with wound or leaf spring to create pinching bias) would be suitable, however, as long as the clip includes a single relatively extended leg element for extending alongside a longitudinal frame element of an eyeglass frame. The relatively extended leg of the spring clip is inserted between a surrounding segment of the heat shrink tubing and an eyeglass frame element segment and is firmly captured against the eyeglass frame segment once the tubing has been heated and reduced in size. Different sizes and colors, including clear/translucent, of heat shrink tubing are included in each kit to provide attachment of the extended clip leg to most any pair of eyeglasses.

There are 3 functional components to the preferred one-piece pinch clip: the “Inner Leg”, the “Pinch Tab”, and the “Outer Leg”. The “Inner Leg” is the part of the clip that is secured to a pair of eyeglasses utilizing heat shrink tubing. The “Pinch Tab” provides a means to easily open the jaws of the clip for ease of securing eyeglasses to the fabric of a shirt pocket. The “Outer Leg” of the clip grasps the pocket fabric so that the eyeglasses resist inadvertently falling out of a shirt pocket and being lost or damaged.

The heat shrink tubing that is preferably used to attach the one-piece pinch clip can come in a wide variety of colors including translucent or clear, heat shrink ratios, lengths and wall thicknesses. Specifically, the acceptable heat shrink ratios can be 2:1, 2.5:1, 3:1, 4:1, and 6:1. The lengths are dependent on a portion of the inner leg of the One-Piece Pinch Pocket Clip. The wall thickness can be thin wall, medium wall, or heavy wall, adhesive lined or dual wall. The material can be Polyolefin, PVC, Kynar, or other heat shrinkable material. In the preferred embodiment, the heat shrink tubing is a 3 to 1 shrink ratio clear polyolefin tubing in ¼″, 5/16″, and ⅜″ diameter and 1⅛″ length.

The one-piece pinch pocket clip can be constructed utilizing a wide variety of materials including but not limited to steel, corrosion resistant stainless steel, aluminum, titanium, plastic or carbon fiber, but is preferably made of #304 stainless steel, Rockwell C40-42, spring temper.

The angles, bends, lengths, and shapes of the preferred embodiment are shown in FIG. 6.

To install the clip onto a pair of eyeglasses, the inner leg of the clip is positioned on the outside of the eyeglasses arm, with the “pinch tab”, which is off-set from the leg, toward the outside of the eyeglasses, and opposite the earpiece. The clip is positioned such that when the eyeglasses are folded up and inserted into the shirt pocket, the pocket fabric will go well inside the clip, and may extend all the way into the pinch tab. With the clip held in place, heat-shrink tubing is slipped over the earpiece of the eyeglasses and over a portion of the inner leg of the clip, and then heated and shrunk. Once shrunk, the heat-shrink tubing secures the clip in place on the eyeglasses. Once the heat-shrink tubing has cooled, the eyeglasses are ready to be clipped onto a shirt pocket utilizing the “Pinch Tab” feature, which open the jaws of the one-piece clip.

After the clip is secured to a pair of eyeglasses and clipped inside a shirt pocket, the eyeglasses resist inadvertently falling out of a shirt pocket and being lost or damaged. The clip can easily be attached to a pair of eyeglasses, thermometer, pencil or any other item with an appropriate cross section that would benefit from being held in a shirt pocket. The clip is secured to the arm of a pair of eyeglasses utilizing heat shrink tubing and a match, simple cigarette lighter or heat gun. The pinch clip can be installed in less than a minute. After the clip is attached, the eyeglasses can be inserted into a shirt pocket, and clipped onto the pocket. The design features a “pinch-tab” which, by squeezing between the thumb and index finger, opens the jaws of the clip for easy insertion and removal of the eyeglasses to and from the pocket.

Finally, it is an object of the present invention to provide a means of clipping eyeglasses to a shirt pocket with ease of use and without special tooling or expertise required to install the clip. The pinch tab on the one-piece clip provides for ease of use. Utilizing heat shrink tubing for mounting the clip provides for ease of installation without any special tools and without special expertise.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows an overall view of a pair of eyeglasses having the clip attached.

FIG. 2 shows an expanded view of the clip positioned on a pair of eyeglasses showing heat shrink tubing before it is shrunk.

FIG. 3 shows the clip being attached to a pair of eyeglasses with heat shrink tubing partially shrunk utilizing a match as the heat source.

FIG. 4 shows where to pinch the clip to open the jaws of the clip.

FIG. 5 shows a pair of eyeglasses being held in a pocket with the clip engaged.

FIG. 6 shows a side view of the clip identifying the bends, movement distance, location for heat shrink tubing and thickness.

FIG. 6a shows what is referred to as the “Inner Leg”, the “Pinch Tab”, the “Outer Leg” and the portion of the leg where heat shrink tubing attaches the clip to the eyeglasses.

FIG. 6b shows a side view of preferred unitary clip depicting suitable angles and dimensions.

FIG. 6c shows the clip mounted with heat shrink tubing on an eyeglasses arm, with the clip held open from force (F).

FIG. 7a shows a top view of the clip. Hidden lines depict bends in the clip.

FIG. 7b shows an end view of the clip. Hidden lines depict hidden bends in the clip.

### DETAILED DESCRIPTION OF THE INVENTION

The present invention is directed to an eyeglasses clip kit and method of attaching. Turning to the figures:

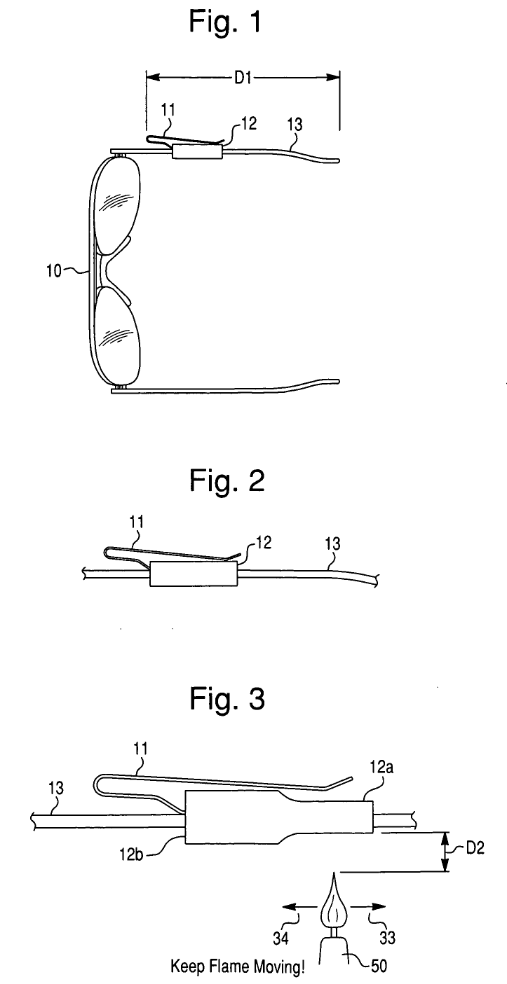

FIG. 1 shows the top view of a pair of eyeglasses (10) with the approximate placement of the pocket clip (11) and heat shrink tubing (12) to be attached to the eyeglasses. Depicted is the clip on the right arm (13) of the eyeglasses which is the preferred arm for right handed individuals. The distance (D1) is the depth of the pocket that will be holding eyeglasses.

FIG. 2 shows an expanded view of the eyeglasses arm (13) clip (11) and heat shrink tubing (12) before it is shrunk.

FIG. 3 shows the heat source in this case a kitchen match (50), the shrunk heat shrink tubing (12a), and the un-shrunk heat shrink tubing (12b) on the eyeglasses arm (13). D2=1″, the distance the flame is held from the heat shrink tubing. The arrows (33) & (34) show the constant movement of the kitchen match in order to successfully shrink the heat shrink tubing.

The attaching step may be accomplished using hot-glue, epoxy, etc., but the heat shrink tubing is preferred inasmuch as it creates fewer steps and is more easily accomplished. If an alternative attaching system is selected, the requirement to not interfere with eyeglass operation and firm attachment must be met at least as well as the heat shrink tubing so that consistent operation of the clip with the pinching operation can be achieved.

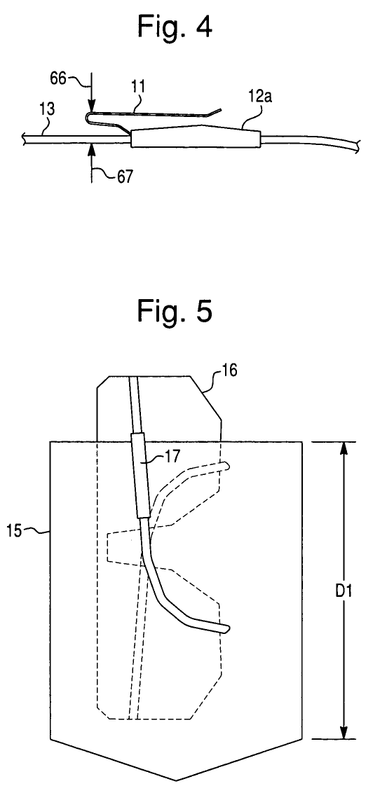

FIG. 4 shows a right hand eyeglasses arm (13), a suitable clip (11) and the completely shrunk heat shrink tubing (12a). The arrows (66) and (67) show where the pocket clip is pinched by a user's digits to open the jaws of the clip.

FIG. 5 shows a shirt pocket (15), a folded up pair of eyeglasses (16) and an installed pocket clip (17) inserted into a shirt pocket. The distance (D1) is the depth of the pocket that will be holding the eyeglasses.

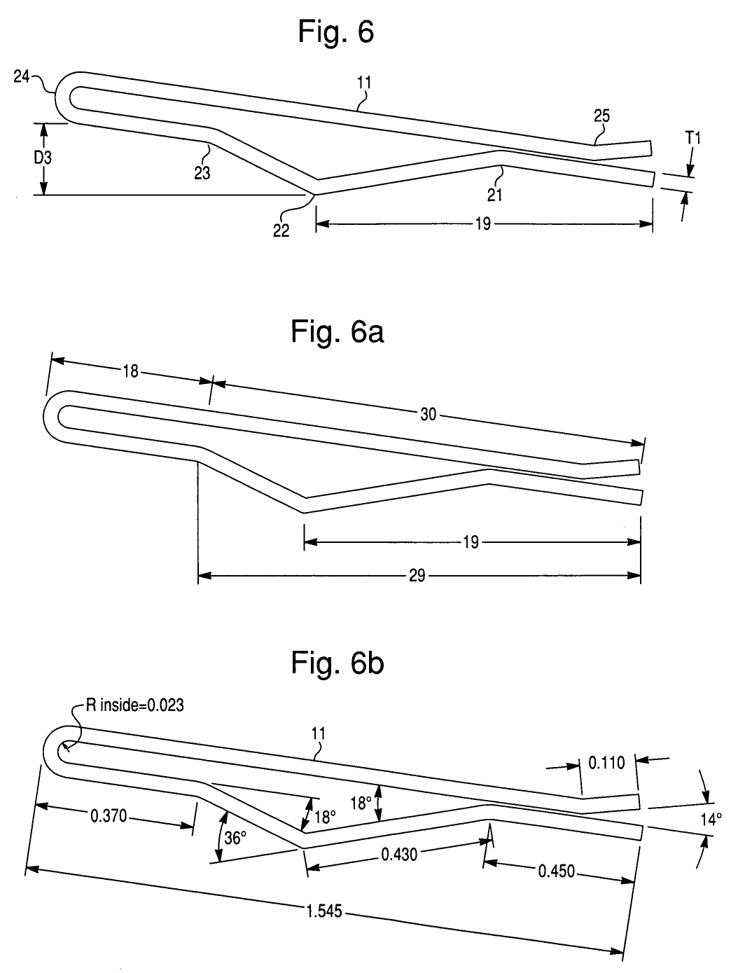

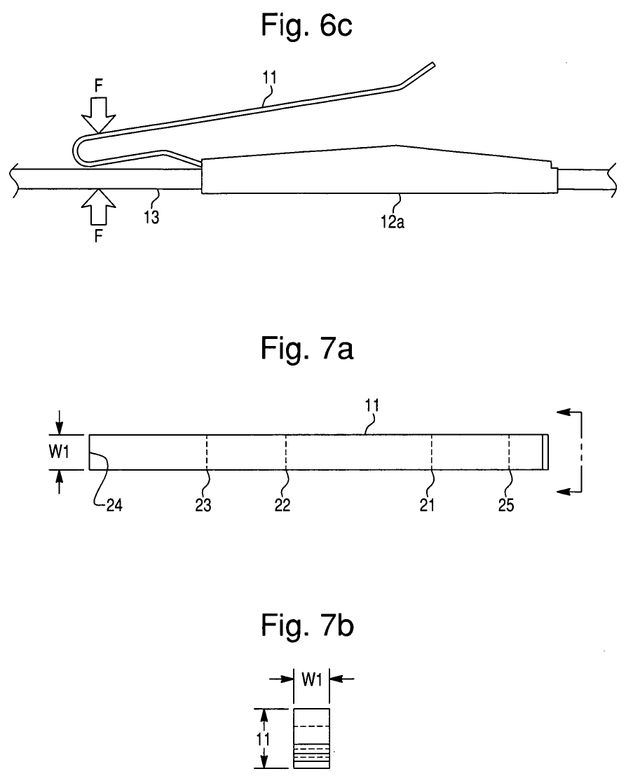

FIGS. 6, 6a, and 6b each show a side view of the preferred unitary One Piece Pinch Pocket Clip (11), bends are identified (21), (22), (23), (24), and (25) and include suitable angular specification (FIG. 6b) for a preferred clip, the portion of the inner leg that is inserted into the heat shrink tubing (19) and the distance the Pinch Tab travels to open the outer leg. The thickness of the material is preferably (Ti)=0.024″ (+/−0.001″).

FIG. 6a shows the Inner Leg (29), the Pinch Tab (18) and the Outer Leg (30). Also shown is the portion of the Inner Leg that is inserted into the heat shrink tubing (19).

FIG. 6b shows the clip (11), all dimensions and all angles of the preferred embodiment of a unitary spring clip used in the present kit. Clearly other dimensions and angles could work, but these are considered to work well.

FIG. 6c shows the clip (11) mounted on an eyeglasses arm (13) with shrunk heat shrink tubing (12a). The clip is being held open by force (F).

FIG. 7a shows a top view of the One Piece Pinch Pocket Clip (11). The width of the material is (W1),=0.108″ (+/−0.002″). The 5 bends in the One Piece Pinch Pocket Clip are also depicted (21), (22), (23), (24) & (25).

FIG. 7b shows an end view of the One Piece Pinch Pocket Clip (11) with exposed edges and hidden bends. The width of the material is (W1).

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. An eyeglasses retrofit clip kit, comprising:
a spring clip having an inner leg connected at one end thereof to an outer leg of said spring clip, said respective legs being connected with sufficient separation therebetween so as to enable said legs to spring bias one toward the other along their length toward respective free ends of said inner leg and said outer leg; and,
a length of heat shrinkable tubing for wrapping a portion of said inner leg free end simultaneously with a temporal/ear element of an eyeglasses frame; such that,
when sufficient heat is applied to said heat shrinkable tubing, said tubing shrinks thereby closely and firmly associates said spring clip inner leg free end to said temporal/ear element of said eyeglasses frame so as to reliably enable a user to open and close said spring clip using pressure from opposed digits of said user.

2. An eyeglasses retrofit clip kit as in claim 1, wherein:
said heat shrink tubing is translucent.

3. An eyeglasses retrofit clip kit, comprising:
a unitary spring clip having an inner leg connected at one end thereof through a continuous extended pinch tab to an outer leg of said spring clip, said pinch tab extending lengthwise from said inner leg and said outer leg and connecting said respective inner and outer legs with sufficient separation therebetween so as to enable said legs to bias one toward the other along their length toward respective free ends of said inner and outer legs; and,
attachment means for associating said inner leg free end firmly with a temporal/ear element of an eyeglasses frame.

4. An eyeglasses retrofit clip kit as in claim 3, wherein:
said attachment means comprises a length of heat shrinkable tubing for wrapping a portion of said inner leg free end simultaneously with a temporal/ear element of an eyeglass frame; such that,
when sufficient heat is applied to said heat shrinkable tubing, said tubing closely associates said unitary spring clip inner leg free end to said temporal/ear element of said eyeglasses frame.

5. An eyeglasses retrofit clip kit as in claim 4, wherein:
said inner leg that is partially wrapped with said heat shrink tubing includes a bend along its length between said free end of said inner leg and a portion of said leg proximal to said pinch tab, wherein said bend creates resilient separation between said leg length including said bend and said wrapped temporal/ear element of said eyeglass.

6. A method of attaching a spring clip to a temporal/ear element of an eyeglasses frame, comprising the steps of:
selecting a spring clip having an inner leg connected at one end thereof to an outer leg of said spring clip, said respective legs being connected with sufficient separation therebetween so as to enable said legs to spring bias one toward the other along their length toward respective free ends of said inner leg and said outer leg; choosing a length and diameter of heat shrinkable tubing that can simultaneously closely wrap a segment of said temporal/ear element of said eyeglasses frame and a portion of the inner leg of said spring clip;
sliding said heat shrink tubing onto and along said temporal/ear element of said eyeglass frame to a pre-selected position;
inserting a portion of the inner leg of said spring clip into said length of heat shrink tubing in position on said eyeglass frame;
heating said tubing so as to cause said tubing to shrink tightly around said eyeglass frame element and a portion of the spring clip inner leg; and,
allowing said heat shrink tubing to cool.

7. A method as in claim 6, wherein:
said spring clip is a unitary spring clip having an inner leg connected at one end thereof through a continuous longitudinally extended pinch tab to an outer leg of said spring clip, said pinch tab extending lengthwise from said inner leg and said outer leg and connecting said respective legs with sufficient separation therebetween so as to enable said legs to bias one toward the other along their length toward respective free ends of said inner leg and said outer leg.

8. A method as in claim 7, wherein:
said length of heat shrink tubing is clear.

9. A unitary spring clip, comprising:
an inner leg, including a bend therein, connected at one end thereof through a continuous longitudinally extended pinch tab, said pinch tab initiating at the inward extent of said bend, to an outer leg of said spring clip, said pinch tab extending lengthwise from said inner leg and said outer leg and connecting said respective legs through a radiused bend creating sufficient separation between said respective legs so as to enable said legs to bias one toward the other along their length toward respective free ends of said inner leg and said outer leg, one of said respective free ends including a further bend to create a flared separation between said respective ends, and wherein when said inner leg is secured to an underlying surface, said unitary spring clip hinges open at a hinge defined by a mid-point of said bend when said pinch tab is urged toward said surface.
